(19) United States
(12) Patent Application Publication
(10) Pub. No.: US 2013/0328913 A1
(43) Pub. Date: Dec. 12, 2013

(54) METHODS FOR VIEWING AND NAVIGATING BETWEEN PERSPECTIVES OF A DATA SET

(71) Applicant: Karim Nassar, Raleigh, NC (US)

(72) Inventor: Karim Nassar, Raleigh, NC (US)

(73) Assignee: ORGBOOK, INC., Durham, NC (US)

(21) Appl. No.: 13/585,908

(22) Filed: Aug. 15, 2012

Related U.S. Application Data
(60) Provisional application No. 61/656,322, filed on Jun. 6, 2012.

(51) Int. Cl. G09G 5/00

(52) U.S. Cl. 345/619

(57) ABSTRACT

Methods for viewing and navigating between perspectives of a data set are described. In one example, a method includes the steps of displaying a view of a data set arranged according to a first perspective and receiving an input associated with an affordance. The method includes the additional steps of determining a view transition based at least in part on the input, displaying the view transition, and updating the view based at least in part on the input.

### CROSS-REFERENCE TO RELATED APPLICATIONS

This application claims priority to U.S. Provisional Application No. 61/656,322, filed 6 Jun. 2012 and entitled “METHODS AND SYSTEMS FOR INTEGRATED SOCIAL MEDIA, STRATEGY, AND ORGANIZATIONAL HIERARCHY”, the contents of which are incorporated herein as if set forth in full.

### FIELD

This invention relates generally to enterprise social media applications, and more specifically to methods for viewing and navigating between perspectives of a data set.

### BACKGROUND

Traditional software applications may provide various ways to view and/or manipulate information in a data set, such as an organization directory. In one conventional approach, the features and tools of such software applications may be accessed according to a series of cascading menu options. In order to view or interact with the data set, users may be forced to navigate a complex menu structure, or alternatively memorize certain keystrokes or shortcuts. However, the logical arrangement of menu items may frequently be inscrutable to or misunderstood by casual users. Thus, various software application tools and features may go underused while users become aggrieved at perceived shortcomings of the software application.

Thus there is a need for new methods to view and navigate a data set.

### SUMMARY

Embodiments of the invention provide methods for viewing and navigating between perspectives of a data set. In one aspect, a method comprises providing an application window comprising a first perspective affordance bar, a second perspective affordance bar, and a first view of a first perspective of a data set. The first perspective affordance bar may comprise at least one first perspective affordance, and be associated with a first perspective of the data set. The second perspective affordance bar may comprise at least one second perspective affordance, and be associated with a second perspective of the data set. The first view may be associated with a first one of the at least one first perspective affordances. The method further comprises receiving an input associated with a second one of the at least one first perspective affordances and determining a transition between the first view and a second view of the first perspective of the data set, the second view associated with the second one of the at least one first perspective affordances, the transition based at least in part on a relationship between the first one and the second one of the at least one first perspective affordances. The method also comprises providing the transition in the application window and providing the second view in the application window.

In another aspect, a method comprises displaying a higher perspective affordance bar comprising one or more higher perspective affordances, the higher perspective affordance bar associated with a higher perspective of a data set, displaying a lower perspective affordance bar comprising one or more lower perspective affordances, the lower perspective affordance bar associated with a lower perspective of the data set, and displaying a first higher perspective view of the data set, the first higher perspective view associated with a first higher perspective affordance of the one or more higher perspective affordances. The method further comprises receiving an input associated with a second higher perspective affordance of the one or more higher perspective affordances and determining a transition between the first higher perspective view and a second higher perspective view associated with the second higher perspective affordance, the transition based at least in part on a relationship between the first higher perspective affordance and the second higher perspective affordance. Finally the method comprises displaying the transition and displaying the second higher perspective view.

Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, serve to explain the principles of the invention and to enable a person skilled in the pertinent art to make and use the invention.

FIG. 1 is a flow chart illustrating a method according to an embodiment.

FIG. 2 is a flow chart illustrating a method according to another embodiment.

FIG. 3 is a flow chart illustrating a method according to another embodiment.

FIG. 4 is a flow chart illustrating a method according to another embodiment.

FIG. 5 is a diagram illustrating a system according to an embodiment.

FIG. 6 is a screenshot illustrating an embodiment.

FIG. 7 is a screenshot illustrating another embodiment.

FIG. 8 is a screenshot illustrating another embodiment.

FIG. 9 is a screenshot illustrating another embodiment.

FIG. 10 is a screenshot illustrating another embodiment.

FIG. 11 is an illustration of an embodiment.

FIG. 12 is another illustration of an embodiment.

### DETAILED DESCRIPTION

Embodiments are described for viewing and navigating between perspectives of a data set. Information in a data set, such as an organization directory or database, may encompass a broad span of organization relationships and personal interactions. By arranging the presentation of the data set into multiple perspectives, with interactions and operations classed or grouped together, embodiments may provide clues to a user about where to expect specific operations and how to navigate the data set. Animated transitions between different views of singe perspective of the data set and/or between different views of different perspectives of the data set may further enlighten users and reinforce their knowledge regarding the arrangement and presentation of the data set, teaching users how to effectively access and interact with the data set.

In one exemplary embodiment, an organization maintains a data set in the form of an Active Directory database. The data set may comprise information related to individual members of the organization, such as their names, pictures, and contact information, as well as information related to the organization hierarchy, such as reporting relationships and team members. An application, such as a web application or mobile application, may provide a graphical user interface to view and interact with the data set.

In the example, the application arranges the presentation of the data set according to multiple perspectives. Each perspective may be presented by the application through one or more views, with each view accessed by an affordance. Affordances, or graphical objects associated with an interaction with the data set, may be associated with a perspective, and presented in affordance bars. As the user navigates the data set by activating or manipulating different affordances, the application may generate animated transitions between views that reflect the organization of the data set and teach users where to expect particular operations.

In the exemplary embodiment, the data set is presented in one of two perspectives. One perspective of the data set comprises an organization perspective, and may be associated with higher, or organization-level relationships, objectives, activities, and/or interactions. A second perspective of the data set comprises a personal perspective, and may be associated with lower, or personal-level relationships, objectives, activities, and/or interactions.

### Illustrated Methods

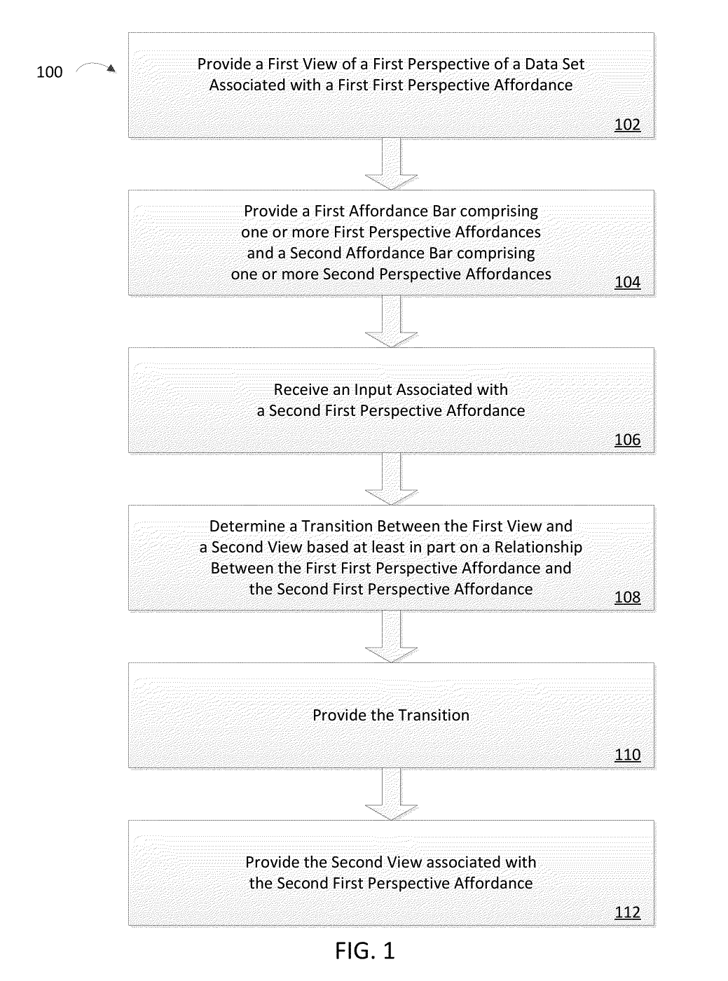

FIG. 1 is a flow chart illustrating a method according to an embodiment. As shown in FIG. 1, in step 102 of method 100, a first view of a first perspective of a data set is provided. The first view may be associated with a first perspective affordance. An application executing in a graphical user interface may provide the first view. A view being currently provided by the application may be referred to as an active view of an active perspective. An active view may be associated with an affordance, referred to as an active affordance.

A data set may comprise information related to an organization, such as an organization directory or organization hierarchy. The data set may be stored in a flat file, or, in one alternative in a database, such as an Active Directory database. In another alternative, a data set may comprise a plurality of files and/or sources. Other examples of a data set may comprise a document repository, or a projects/tasks database.

An application or application window displayed in a graphical user interface may generate one or more views of the data set. The application may comprise a web application viewed in a web browser, or a native platform application, such as an iOS iPad application, Android phone application, Windows Phone application, or some other native device application.

The presentation of a data set in a view may be arranged according to a perspective. In one embodiment, the presentation of the data set is arranged according to at least two perspectives. In other embodiments, the presentation of the data set is arranged according three or more perspectives. In one example illustrated below, a data set is presented in a first view according to a personal perspective and presented in a second view according to an organization perspective. In another example, the presentation of a plurality of views of a data set may be arranged according to a higher perspective, an intermediate perspective, and a lower perspective.

A view of the data set may be associated with an affordance. An affordance may comprise a graphical object associated with an interaction with the data set. An affordance may be provided, or displayed, in a user interface as a graphical object such as an icon, a button, text navigation link (i.e. hyperlink), or a text entry field. An affordance may comprise implicit or explicit cues for how to interact with the affordance. As one example, a text field affordance may initially comprise shaded text reading “search by first or last name.” As another example, an affordance may change color, shape, or size, when a user moves a mouse cursor over the affordance (i.e. mouse-over), indicating that selecting the affordance may trigger some action.

Examples of affordances include, but are not limited to, a profile affordance, a recents affordance, a favorites affordance, a status affordance, a scratch pad affordance, an organization chart affordance, and a search affordance. Each view may associated with an affordance. Examples of views include a profile view, a recents view, a favorites view, a scratch pad view, an organization chart view, a search view, a personal configuration/preferences view, and an organization configuration view. In order to access the profile view, a user may activate a profile affordance. Similarly, in order to access a favorites view, a user may activate a favorites affordance. However, an affordance may not be associated with a view. For example, a log-out affordance may not be associated with any view, but when activating, cause the application to log-out a user and close the application.

In one embodiment, each affordance may be associated with a perspective. For example, a profile affordance, a recents affordance, a favorites affordance, and a status affordance may be associated with a personal perspective while an organization chart affordance and a search affordance may be associated with an organization perspective.

In step 104, a first affordance bar and a second affordance bar may be provided. Each affordance bar may comprise one or more affordances. In method 100, the first affordance bar may comprise one or more first perspective affordances, and the second affordance bar may comprise one or more second perspective affordances. In one embodiment, an affordance bar may comprise a horizontal bar comprising a plurality of graphical user objects, such as icons.

An affordance bar may be a horizontal or vertical bar. In one embodiment, each affordance bar may be aligned in the same direction. For example, each affordance bar may be a horizontal bar extending the length of the application window. As another example, each affordance bar may be a vertical bar extending the height of the application window. In another embodiment, one or more affordance bars may be aligned in different directions. For example, a first affordance bar and a second affordance bar may be horizontal bar, while a third affordance bar may be a vertical bar. Each affordance bar may be the same length and/or height, or alternatively, one or more of the affordance bars may be longer or shorter than other affordance bars.

An affordance bar may be linked to, or correspond to, a perspective of the data set. In one example, an application may arrange a data set into a personal perspective and an organization perspective. Accordingly, the application may provide a personal perspective affordance bar and an organization perspective affordance bar.

One or more affordance bars may always be visible. In one embodiment, all of each affordance bar may always be visible in an application window. In another embodiment, a portion of each non-active affordance bar may always be visible, while the entire portion of an active affordance bar may be visible while an associated perspective is being presented.

An active view and/or an active affordance bar may comprise an indication of an active affordance. In one example, a search view of an organization perspective may be provided. Below a search affordance, a small graphical indicator, such as an arrow, may be provided, to inform the user of the active affordance. In another example, an active affordance may be highlighted, or provided in a different color and/or intensity than other non-active affordances.

In one embodiment, one or more affordances may be arranged on an affordance bar according to most frequent use. For example, the most frequently used affordance may be provided on the left of a horizontal affordance bar, while the least frequently used affordance may be provided on the right of a horizontal affordance bar. As an affordance becomes more frequently used, the application may dynamically shift the arrangement and/or placement of affordances on the affordance bar. Alternatively, the placement of the affordances may be fixed. In one embodiment, one or more affordances may be arranged on an affordance bar according to importance.

In step 106, an input may be received. The input may be associated with an affordance, for example, a second first perspective affordance. In one embodiment, a user may indicate a desire to switch views of a perspective of a data set by selecting or manipulating a non-active affordance.

Some affordances may be activated through a selection input. For example, a user may click, tap, or otherwise select an affordance to activate the affordance. Some affordances may accept other types of user input. For example a user may drag a profile into a scratch pad affordance, type a status into a status affordance, or type a partial name into a search affordance.

In step 108, a transition may be determined between the first view and a second view. The determination may be based at least in part on a relationship between the first affordance and the second affordance. In one embodiment, a relationship between the affordances may be a spatial relationship, such as the relative placement of each affordance on their respective affordance bar.

In one example, a user may intend to switch views of a perspective. The user may be viewing a profile view of a personal perspective of a data set. The profile affordance may be arranged as the left most affordance on a personal perspective affordance bar. The user may click on the favorites affordance in the personal perspective affordance bar, which may be arranged to the right of the profile affordance on the personal perspective affordance bar.

In Step 110, the application may provide the transition. In one embodiment, the application displays an animated transition between the first view and the second view. For example, the first view may fade out, and the second view may fade in. As another example, the first view may shift to one side of the application window, away from the center of the application window, while the second view shifts into the center of the application window from the opposite side. Different forms of animated transitions may be combined in the same transition.

In one embodiment, a transition comprises an affordance transition. An affordance transition may graphically indicate a transition, or shift, from a first view of a first perspective to a second view of the first perspective. In one embodiment, an affordance transition comprises a horizontal, or lateral transition. For example, an affordance transition may comprise the movement, or shifting, of a first view to one side of an application window and the movement, or shifting of a second view from the opposite of the application window to the middle of the application window.

In another embodiment, a transition comprises a perspective affordance. A perspective affordance may graphically indicate a transition, or shift, from a first perspective to a second perspective. In one embodiment, a perspective transition comprises a vertical transition. For example, a perspective transition may comprise an affordance bar positioned at the bottom of the screen moving up to cover a first view of a first perspective and reveal a second view of a second perspective. In another example, a perspective transition may comprise an affordance bar positioned near the top of the screen to move down, hiding a first view of a perspective and revealing a second view of a second perspective.

Before, during, or after a transition, the state of the first view may be saved. For example, a user may be viewing an organization hierarchy in an organization chart view. When an input associated with a search affordance is received, the location of the organization hierarchy being presented in the organization charge view may be saved. Later, if an input associated with an organization chart is received, the saved state of the organization chart view may be presented. In another embodiment, a state of the first view may not be saved.

In step 112, the application may provide the second view. The second view may be associated with the second first perspective affordance. In one embodiment, only one view is provided by an application window at one time. For example, after a transition from a first view to a second view, the first view may be hidden, while the second view is shown. In the example, each affordance bar may remain in view of the application window. In another embodiment, a portion of a non-active view may be shown on either side of an application window, adjacent to an active view. For example, multiple views may be presented as a horizontal carousel, with an active view in the middle of the application window, and adjacent views flanking the active view on either side of the application window. In the example, a user may navigate views within the horizontal carousel by selecting a different affordance, or alternatively, by swiping across the views.

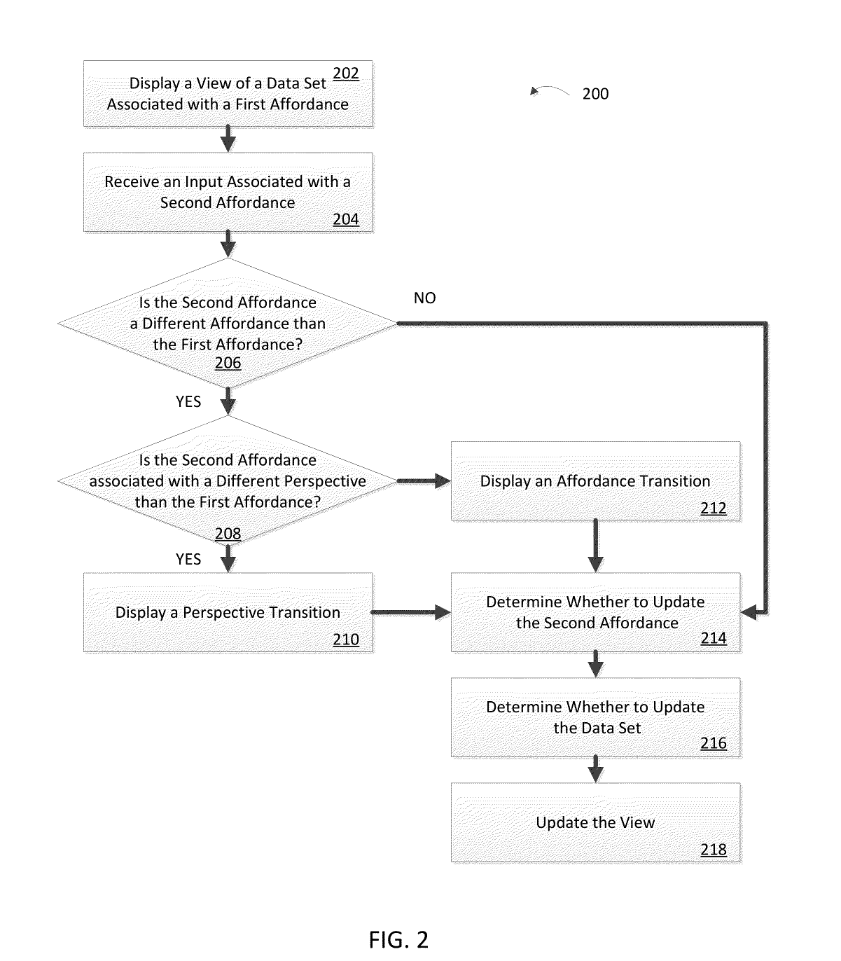

FIG. 2 is a flow chart illustrating a method according to another embodiment. In step 202, a view of a data set is displayed. The displayed view (i.e. the active view) may be associated with a first affordance (i.e. the active affordance). As an example, a recents view associated with a recents affordance may be displayed. The recents affordance may be positioned on an affordance bar provided, or displayed, above the first view.

In step 204, an input associated with a second affordance is received. For example, a user may tap, or select, an affordance provided on an affordance bar above the view. As another example, a user may drag an object shown in the active view to an affordance shown in the affordance bar.

In step 206, it is determined whether the second affordance is different than the first affordance. In one embodiment, a user may intentionally or accidentally select the active affordance associated with the active view. If it is determined that the second affordance associated with the input is the same as the first affordance, than method 200 continues to step 214.

In another embodiment, a user may activate or trigger a different affordance than the active affordance. If it is determined that the second affordance associated with the input is different than the first affordance, than method 200 continues to step 208. In step 208, it is determined whether the second affordance is associated with a different perspective than the first affordance. In one embodiment, a user input associated with an affordance different than the active affordance comprises an indication to switch or navigate views.

If it is determined in step 208 that the second affordance is associated with a different perspective than the first affordance, method 200 proceeds to step 210. In step 210, a perspective transition is displayed. As discussed above, a perspective transition may comprise an animated transition of one or more affordance bars. For example, an affordance bar may scroll up, scroll down, or scroll from one side of the application window to the opposite side of the application window.

If it is determined in step 208 that the second affordance is not associated with a different perspective than the first affordance (i.e. the second affordance is associated with the same perspective as the first affordance), than method 200 proceeds to step 212. In step 212, an affordance transition is displayed. As discussed above, an affordance transition may comprise an animated transition of views. In one example, the affordance bars remain stationary during an affordance transition, while the view is updated, or shifts.

In step 214, it is determined whether to update the second affordance. In some embodiments, an input may trigger a change in an affordance, such as a change in the appearance of an affordance. As one example, a profile affordance may display a user's profile picture. A user may generate an update to a data set, such as by updating their profile picture in a profile view. In response, the application may update the profile affordance to show the user's new profile picture. As another example, an organization hierarchy may be shown in an organization chart view. A user may “favorite” an organization member shown in the organization chart view by clicking an icon in the organization chart view. The application may flash, or briefly animate, the favorites affordance, which may indicate that the non-active favorites view has been updated by the user's input.

In other embodiments, an input may not trigger a change in an affordance. As one example, an application may receive an input selecting a non-active affordance. For example, a user may be viewing a recents view, and select a favorites affordance. The application may then switch to a favorites view without changing, or updating the favorites affordance.

In step 216, it is determined whether to update the data set. In some embodiments, an input may be associated with an update to a data set. For example, a data set may comprise one or more profile pictures. A user may update a profile picture in a profile view. In response, the application may update the data set with the updated profile picture. Additionally, a profile affordance may be updated with the updated profile picture. As another example, a data set may comprise a status of an organization member. The organization member may update their status by entering text into a status affordance.

In other embodiments, an input may not be associated with an update to a data set. For example, a user may enter a partial name into a search affordance to search for organization members matching the partial name. Although a search view may be updated with matching search results, the underlying data set may not be updated or changed based on a search.

In step 218, the view is updated. In one embodiment, the second affordance associated with an input is different than the first affordance, or active affordance. In such embodiments, the first view may be updated to a second view associated with the second affordance. In another embodiment, the view may not be updated. For example, a user may accidentally or inadvertently select the active affordance. In the example, the first view would not be updated. Alternatively, the first view may be updated by momentarily flashing the first view, which may indicate that the user has selected the active affordance associated with the active view, rather than a non-active affordance associated with a different view.

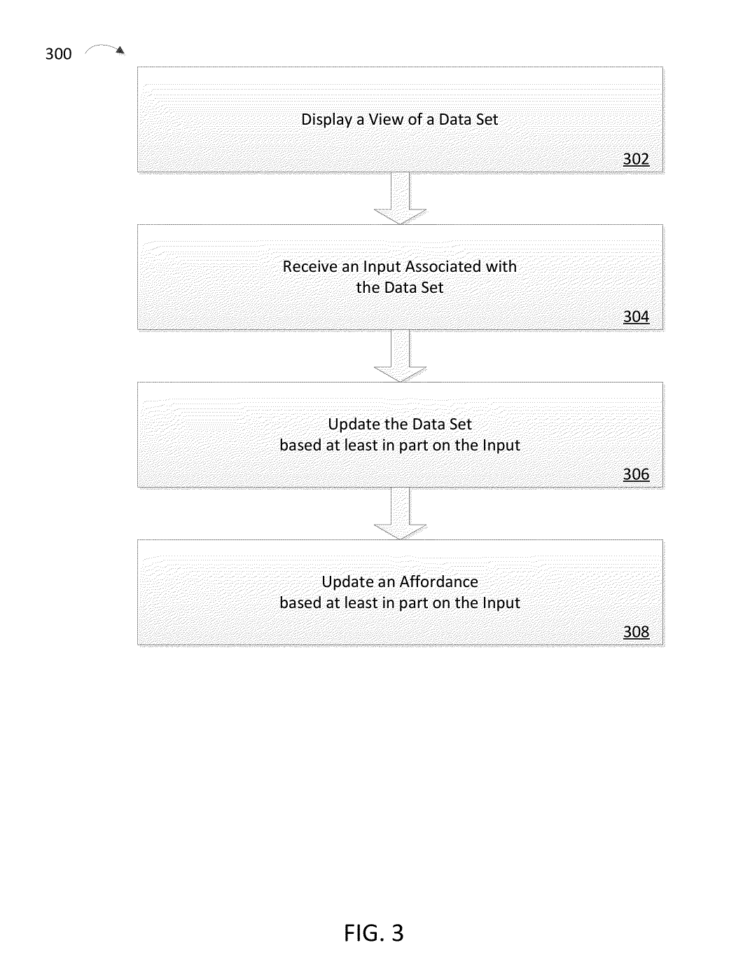

FIG. 3 is a flow chart illustrating a method according to another embodiment. In step 302, a view of the data set is displayed. The view may be associated with an affordance, i.e. an active affordance. An application window may provide, or display, the view within a web browser, or, in one alternative, within a tablet application, such as an iPad application or a Windows Phone application.

In step 304, an input associated with the data set is received. In one embodiment, an input may be received from a user interacting with the local application. For example, an application may display a member profile in a profile view. A user may change, or update, information displayed in the profile, such as a phone number, biography, or picture.

In step 306, the data set is updated based at least in part on the input. In one example, after a user selects a picture for updating a member profile, the data set is updated with the picture.

In step 308, an affordance is updated based at least in part on the input. In the example, after a data set is updated with a new picture input by a user, a profile affordance may be updated to show the new picture.

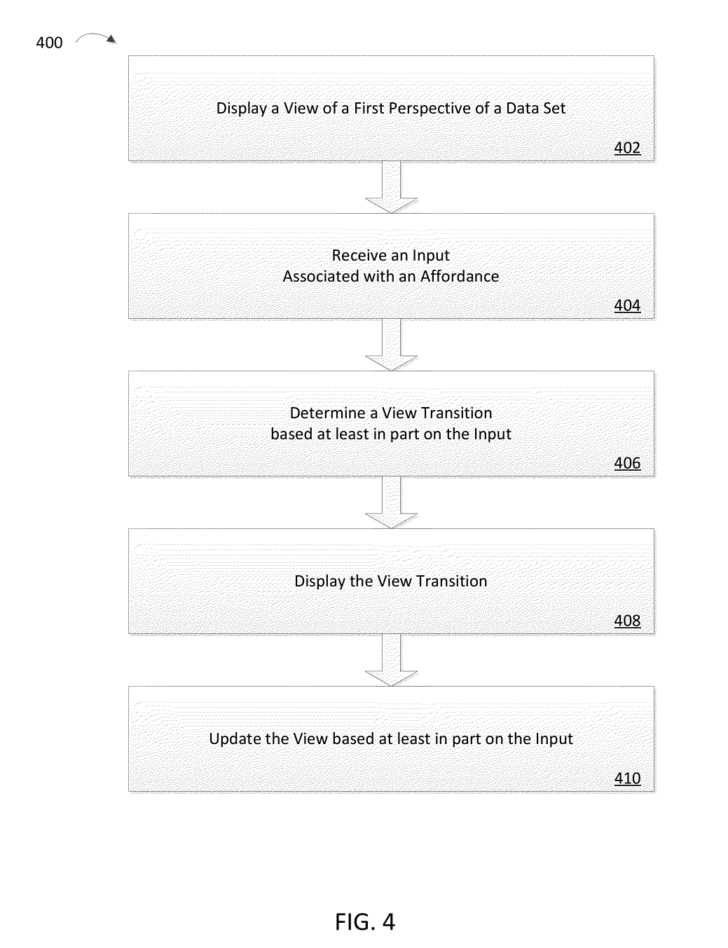

FIG. 4 is a flow chart illustrating a method according to another embodiment. In step 402, a view of a first perspective of a data set is displayed. The view may be associated with an affordance, i.e. an active affordance. An application window may provide, or display, the view within a web browser, or, in one alternative, within a tablet application, such as an iPad application or a Windows Phone application.

In step 404, an input associated with an affordance is received. Embodiments of an affordance may accept various forms of input and/or be triggered according to different actions. In some embodiments, an affordance may be activated or triggered via a selection input. In other embodiments, an affordance may be activated or triggered via a text input, e.g. through a text field, or via a drag-and-drop input, such as with a scratch pad affordance.

In step 406, a view transition is determined based at least in part on the input. In some embodiments, a view transition may comprise a perspective transition, such as a transition from the first perspective to a second perspective. In other embodiments, a view transition may comprise an affordance transition, such as a transition from a view associated with a first affordance of the first perspective to a view associated with a second affordance of the first perspective.

In step 408 the view transition is displayed. The view transition may comprise an an animated transition. In one embodiment, views associated with different affordances of a first perspective are arranged across a virtual horizontal plane, while views associated with different perspectives are arranged across a virtual vertical plane. In the embodiment, a view transition between affordances in a single perspective may comprise a horizontal animation, while a view transition between different perspectives may comprise a vertical animation.

In step 410, the view is updated based at least in part on the input. The original view may be replaced in the application window by an updated view. The updated view may be associated with the input affordance.

### Illustrated System

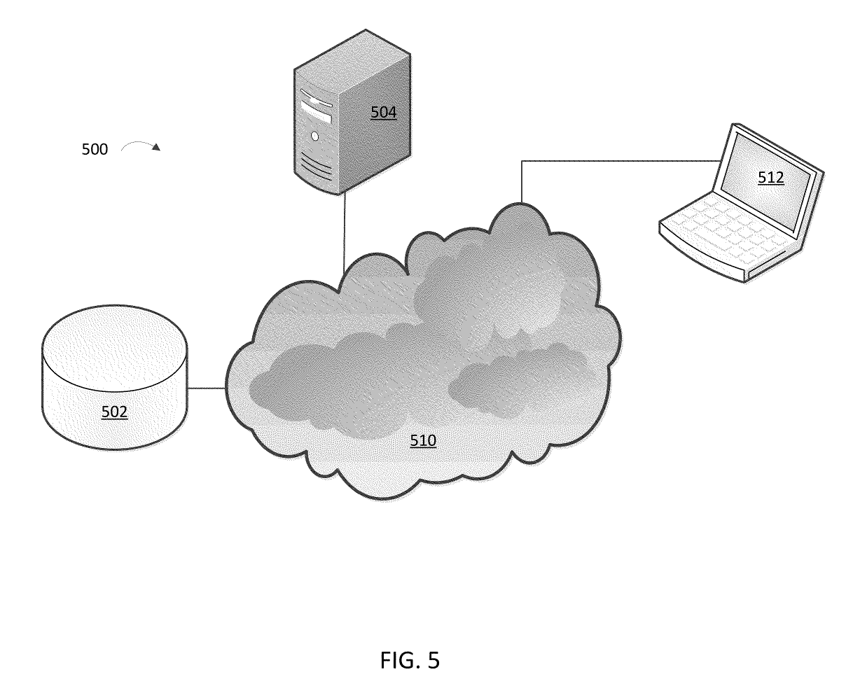

FIG. 5 is a diagram illustrating a system of according to embodiment. System 500 comprises data store 502, server 504, and client device 512. Server 504, data store 502, and client device 512 may be in communication over network 510. Data store 502 may comprise one or more repositories for data, such as one or more databases. In one embodiment, data store 502 comprises an Active Directory database. In another embodiment, data store 502 comprises a corporate directory. Communication devices include laptop computer 512, tablet 514 and smart phone 516. In other embodiments, other types of communication devices may be used.

An application, such as an organization hierarchy viewer, may be presented within a graphical user interface executing on one or more communication device 512, 514, 516. The application may comprise a native mobile device application such as an iOS iPad application, a Windows Phone application, or an Android application. As one alternative, the application may comprise a web application accessed through a web browser.

### Illustrated Screenshots

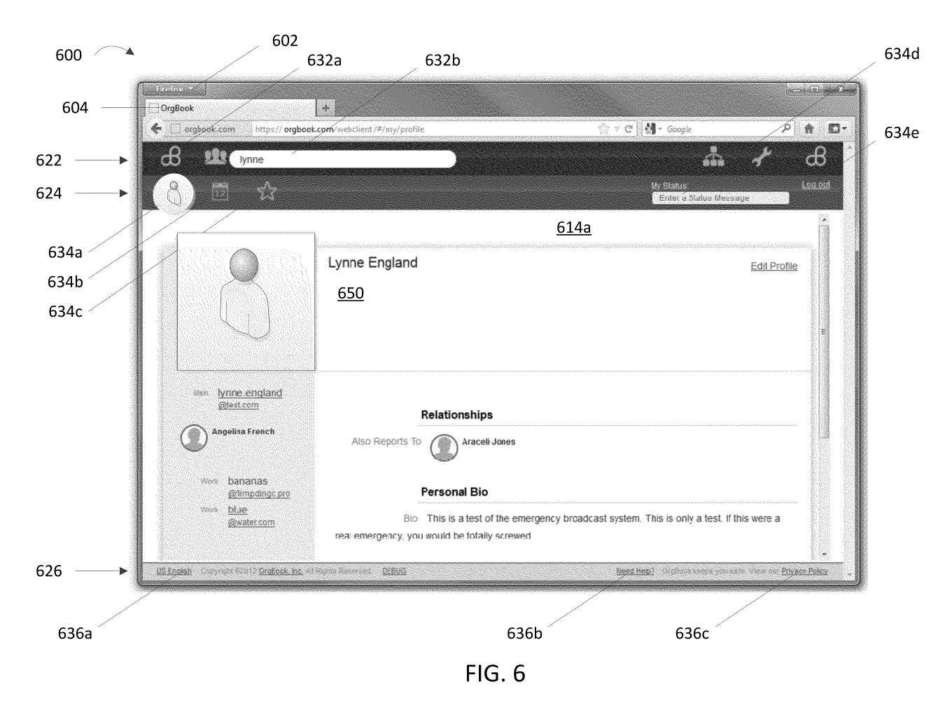

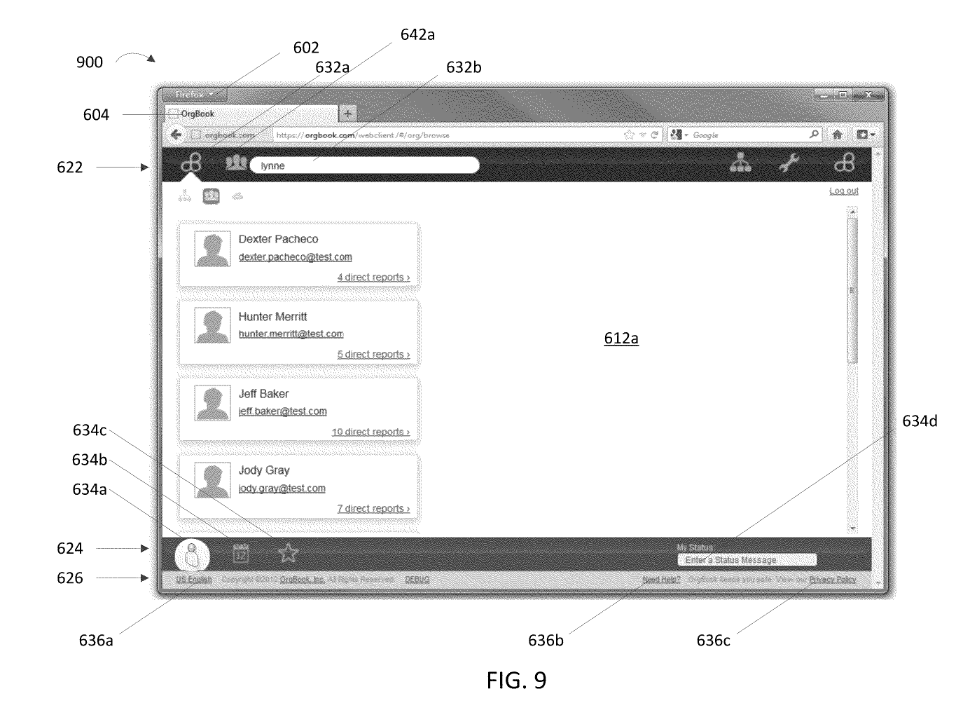

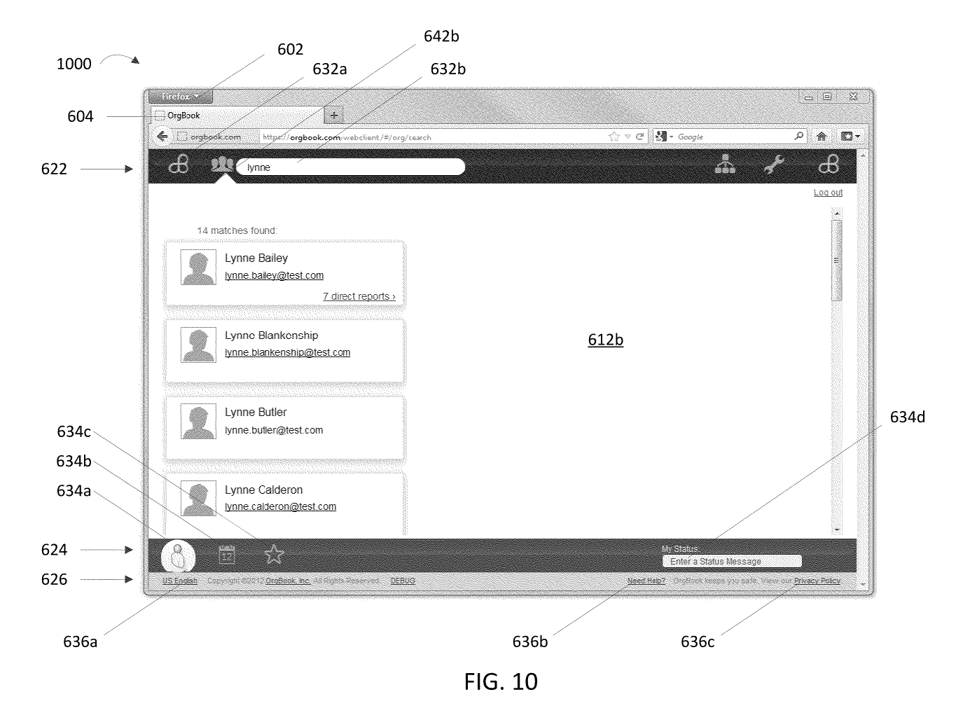

FIGS. 6-10 are screenshots illustrating embodiments for viewing and navigating perspectives of a data set. FIGS. 6-8 illustrate a first perspective of a data set, and FIGS. 9-10 illustrate a second perspective of a data set. In embodiments, a data set may be divided into two, three, or more perspectives. FIGS. 6-10 comprise screenshots 600, 700, 800, 900, 1000 of web application 604 executing in web browser 602.

Turning to FIG. 6, web application 604 has arranged a data set into three perspectives: an organization perspective, a personal perspective, and a meta perspective. In other embodiments, an application may arrange a data store into any number of perspectives. Web application 604 provides organization perspective affordance bar 622, personal perspective affordance bar 624, and meta affordance bar 626. Web application 604 also provides profile view 614a.

As illustrated in FIG. 6, affordance bars 622, 624, 626 comprise horizontal bars, each including a plurality of affordances. In other embodiments, one or more affordance bars may comprise vertical bars, and may include one or more affordances.

Organization perspective affordance bar 622 comprises organization perspective affordances 632a, 632b, including organization chart affordance 632a and organization search affordance 632b. As shown in FIG. 6, organization chart affordance 632a is depicted as a graphical icon, and organization search affordance 632b is depicted as a text input field. In other embodiments an affordance may comprise other types of graphical objects.

Personal perspective affordance bar 624 comprises personal perspective affordances 634a, 634b, 634c, 634d, 634e including profile affordance 634a, recents affordance 634b, favorites affordance 634c, status affordance 634d and logout affordance 634e. Some affordances may not be associated with a view. Logout affordance 634e, for example, may trigger the application to log a user out and close the application, without displaying an associated view. Other affordances may be associated with a view. As shown in FIG. 6, profile view 614a may be associated with profile affordance 634a. Profile view 614a displays one view of the personal perspective of the data set.

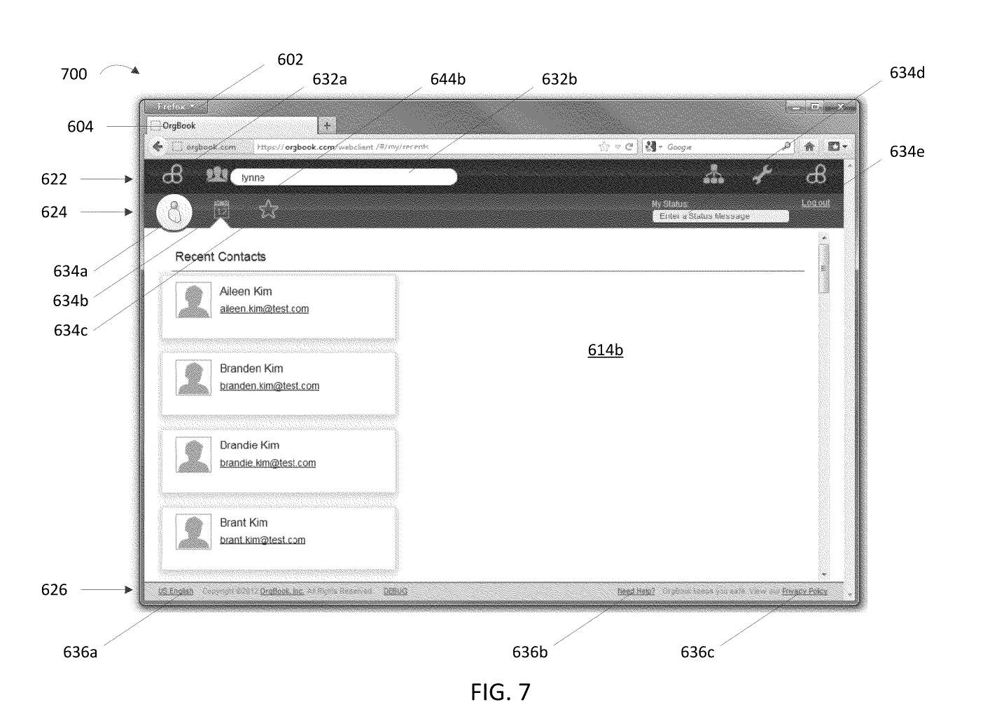

FIG. 7 is a screenshot illustrating another embodiment. As illustrated in FIG. 7, web application 604 displays a second view of the personal perspective in the form of recents view 614b. Recents view 614b may be associated with recents affordance 634b. Web application 604 also displays indicator 644b. Indicator 644b may provide an indication of the affordance associated with the active view. As shown in FIG. 7, indicator 644 points to recents affordance 634b, indicating that a view associated with recents affordance 634b (e.g. recents view 614b) is the active view.

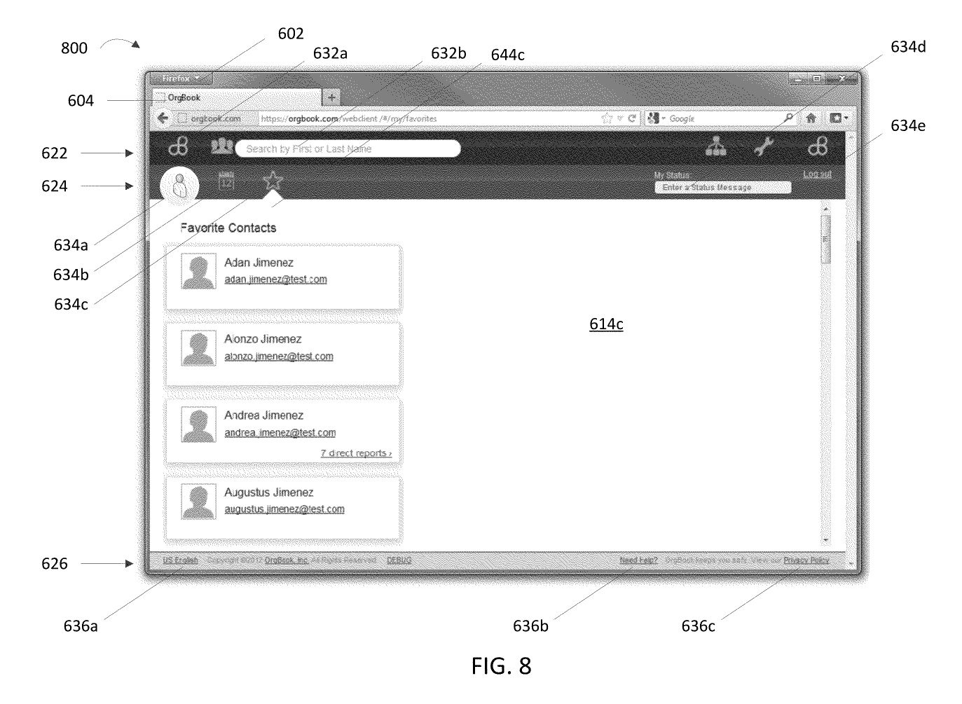

FIG. 8 is a screenshot illustrating another embodiment. As illustrated in FIG. 8, web application 604 displays a third view of the personal perspective in the form of favorites view 614c. Favorites view 614c may be associated with favorites affordance 634c. Web application 604 also displays indicator 644c, depicted below favorites affordance 634c. Indicator 634c may indicate that a view associated with favorites affordance 634c (e.g. favorites views 614c), is the active view.

A user may transition between first perspective views 614a, 614b, 614c by activating or triggering the corresponding affordance. As an example, a user may intend to transition from profile view 614a, shown in FIG. 6, to favorites view 614c, shown in FIG. 8. An input may be received associated with favorites affordance 634c, such as a selection input. After an input associated with favorites affordance 634c is received, a transition between profile view 614a and favorites view 614c may be determined.

The transition may be based at least in part on a relationship between profile affordance 634a and favorites affordance 634c. Because profile affordance 634a and favorites affordance 634c are both personal perspective affordances, a lateral affordance transition may be provided. Further, because favorites affordance 634c is positioned to the right of profile affordance 634a, a transition in the form of a left-to-right animation may be determined.

FIGS. 9-10 are screenshots illustrating a second perspective of a data set. As illustrated in FIG. 9, web application 604 displays a first view of the organization perspective in the form of organization chart view 612a. Organization chart affordance 632a comprises the active affordance and is highlighted by active affordance indicator 642a.

FIG. 10 is a screenshot illustrating another embodiment. As illustrated in FIG. 10, web application 604 displays a second view of the organization perspective in form of organization search view 612b. As shown in FIG. 10, organization search affordance 632b comprises the active affordance and is highlighted by active affordance indicator 642b.

A user may transition between personal perspective views 614a, 614b, 614c and organization perspective views 612a, 612b by activating or triggering the corresponding affordance. As an example, a user may intend to transition from recents view 614b, shown in FIG. 7, to organization search view 612b, shown in FIG. 10. An input may be received associated with organization search affordance 632b, such as a text input of one or more characters or numbers. After an input associated with organization search affordance 632b is received, a transition between recents view 614b and organization search view 612b may be determined.

The transition may be based at least in part on a relationship between recents view 614b and organization search view 612b. Because recents affordance 614b and organization search affordance 612b are associated with different perspectives, a vertical perspective affordance may be provided. After the vertical perspective transition is displayed, organization search view 612b may be displayed.

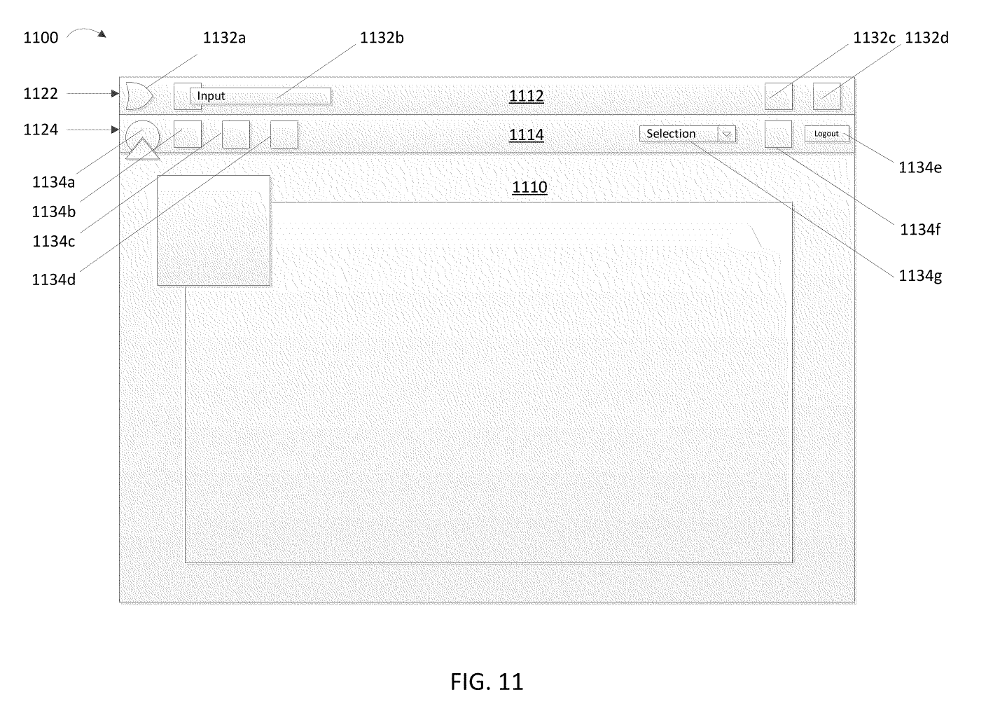

FIG. 11 is an illustration 1100 of an embodiment. Illustration 1100 may represent a graphical user interface generated by platform native application, such as a Windows Phone application, or a web application. As shown in FIG. 11, an application generates first perspective navigation bar 1112 and second perspective navigation bar 1114. First perspective navigation bar 1112 comprises first perspective affordances 1132a, 1132b, 1132c, 1132d. Second perspective navigation bar comprises second perspective affordances 1134a, 1134b, 1134c, 1134d, 1134ed, 1134f, 1134g. The active view of the data set, shown in FIG. 11 as view 1110, may be associated with second perspective affordance 1134a.

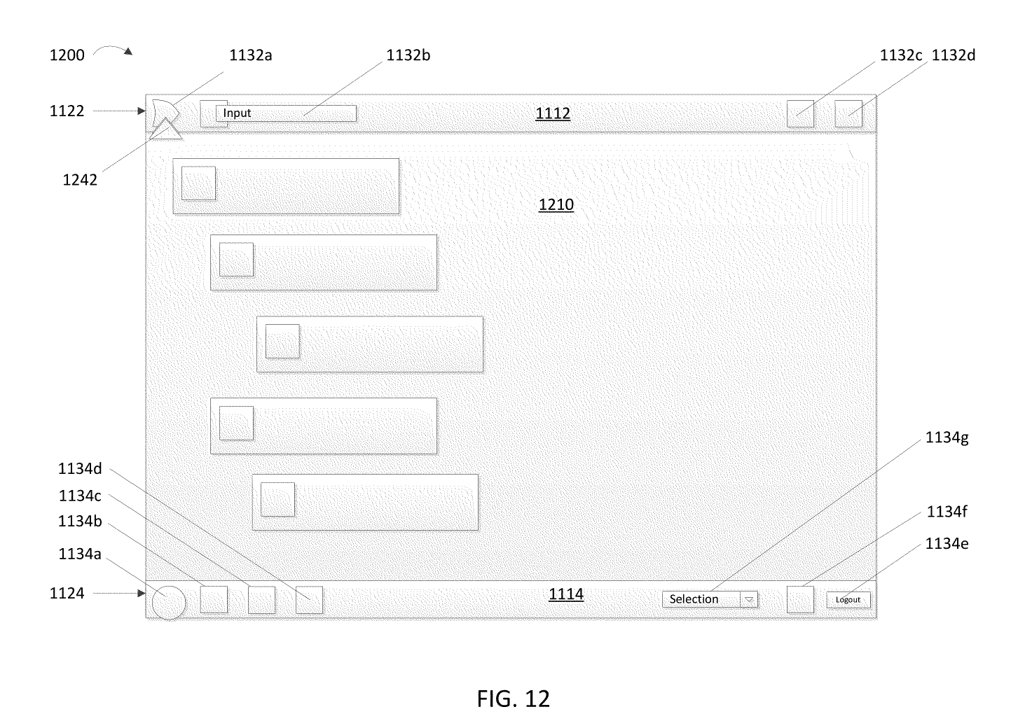

FIG. 12 is another illustration 1200 of an embodiment. In Illustration 1200, the active view of the data set, view 1210, may be associated with first perspective affordance 1132a, as indicated by active affordance indicator 1242.

Scope

Embodiments of a subset or all and portions or all of the above may be implemented by program instructions stored in a memory medium or carrier medium and executed by a processor. A memory medium may be a transitory medium or non-transitory medium. A memory medium may include any of various types of memory devices or storage devices. The term “memory medium” is intended to include an installation medium such as a Compact Disc Read Only Memory (CD-ROM) floppy disks, tape device, a computer system memory or random access memory such as Dynamic Random Access Memory DRAM Double Data Rate Random Access Memory DDR RAM Static Random Access Memory SRAM Extended Data Out Random Access Memory EDO RAM Rambus Random Access Memory RAM etc. or a non-volatile memory such as a magnetic media e.g. a hard drive or optical storage. The memory medium may comprise other types of memory as well or combinations thereof. In addition the memory medium may be located in a first computer in which the programs are executed or may be located in a second different computer that connects to the first computer over a network such as the Internet. In some instances the second computer may provide program instructions to the first computer for execution. The term memory medium may include two or more memory mediums that may reside in different locations e.g. in different computers that are connected over a network.

In some embodiments a computer system at a respective participant location may include a memory medium s on which one or more computer programs or software components according to one embodiment of the present invention may be stored For example the memory medium may store one or more programs that are executable to perform the methods described herein The memory medium may also store operating system software as well as other software for operation of the computer system.

Modifications and alternative embodiments of one or more aspects of the invention may be apparent to those skilled in the art in view of this description. Accordingly this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art rely after having the benefit of this description of the invention. Changes may be made in the elements described herein without departing from the spirit and scope of the invention as described above and below.

What is claimed is:

1. A method for viewing and navigating between perspectives of a data set, comprising:
displaying a view of a data set arranged according to a first perspective;
receiving an input associated with an affordance;
determining a view transition based at least in part on the input;
displaying the view transition;
updating the view based at least in part on the input.

2. A method for viewing and navigating between perspectives of a data set in a graphical user interface, comprising the steps of:
providing an application window comprising
a first perspective affordance bar comprising at least one first perspective affordances, the first perspective affordance bar associated with a first perspective of a data set,
a second perspective affordance bar comprising at least one second perspective affordance, the second perspective affordance bar associated with a second perspective of a data set, and
a first view of the first perspective of the data set, the first view associated with a first one of the at least one first perspective affordances;
receiving an input associated with a second one of the at least one first perspective affordances;
determining a transition between the first view and a second view of the first perspective of the data set, the second view associated with the second one of the at least one first perspective affordances, the transition based at least in part on a relationship between the first one and the second one of the at least one first perspective affordances;
providing the transition in the application window;
providing the second view in the application window.

3. The method of claim 2, before the step of providing the second view, further comprising:
saving a state of the first view.

4. The method of claim 2, wherein providing an application window further comprises:
providing an indicator of an affordance associated with the first view.

5. The method of claim 2, wherein the data set comprises an organization information database.

6. The method of claim 5, wherein the first perspective comprises an organization perspective and the second perspective comprises a personal perspective.

7. The method of claim 2, wherein an affordance comprises a graphical object associated with at least one interaction with the data set,
each one of the at least one first perspective affordances comprises a graphical object associated with at least one interaction with the first perspective of the data set, and
each one of the at least one second perspective affordances comprises a graphical object associated with at least one interaction with the second perspective of the data set.

8. The method of claim 2, wherein the first perspective affordance bar comprises a first horizontal affordance bar and the second perspective affordance bar comprises a second horizontal affordance bar.

9. The method of claim 2, wherein the transition between a first view and a second view comprises an animated transition.

10. The method of claim 2, wherein the input comprises a first input and the transition comprises a first transition and further comprising:
receiving a second input associated with a first one of the at least one second perspective affordances;
determining a second transition between the second view and a third view of the second perspective of the data set, the third view associated with the first one of the at least one second perspective affordances;
providing the second transition in the application window;
providing the third view in the application window.

11. The method of claim 2, wherein the input comprises a first input, and further comprising:
receiving a second input associated with a second perspective affordance; and
updating the data set based at least in part on the second input.

12. The method of claim 11, wherein the second perspective affordance comprises a scratchpad affordance, and the second input comprises dragging an object to the scratchpad affordance.

13. The method of claim 2, wherein the input comprises a first input, and further comprising:
detecting a second input, the second input associated with a first perspective affordance;
updating the appearance of the first perspective affordance based at least in part on the second input.

14. The method of claim 13, wherein detecting the second input comprises detecting an input within a predetermined proximity to the first perspective affordance.

15. The method of claim 14, wherein updating the appearance of the first perspective affordance comprises enlarging the first perspective affordance.

16. The method of claim 2, wherein the input comprises a first input, and further comprising:
receiving a second input associated with the data set; and
updating an affordance based at least in part on the second input.

17. The method of claim 16, wherein the second input comprises receiving an update to a contact profile image, and updating the affordance comprises updating an image in the affordance.

18. The method of claim 2, wherein at least a portion of the first affordance bar and at least a portion of the second affordance bar are always visible in the application window.

19. The method of claim 2, wherein the application window further comprises
a third perspective affordance bar comprising at least one third perspective affordance, the third perspective affordance bar associated with a third perspective of a data set.

20. The method of claim 19, wherein the third perspective is an application perspective.

21. A method for viewing and navigating between views of a data set in a graphical user interface, comprising the steps of:
displaying a higher perspective affordance bar comprising one or more higher perspective affordances, the higher perspective affordance bar associated with a higher perspective of a data set;
displaying a lower perspective affordance bar comprising one or more lower perspective affordances, the lower perspective affordance bar associated with a lower perspective of the data set;
displaying a first higher perspective view of the data set, the first higher perspective view associated with a first higher perspective affordance of the one or more higher perspective affordances;
receiving an input associated with a second higher perspective affordance of the one or more higher perspective affordances;
determining a transition between the first higher perspective view and a second higher perspective view associated with the second higher perspective affordance, the transition based at least in part on a relationship between the first higher perspective affordance and the second higher perspective affordance;
displaying the transition;
displaying the second higher perspective view.

22. The method of claim 21, wherein the relationship comprises a lateral adjacency relationship and the transition comprises a substantially horizontal animation.

23. The method of claim 21, wherein the first affordance bar comprises the first one of the plurality of affordances, the second affordance bar comprises the second one of the plurality of affordances, and the transition comprises a vertical transition.

24. The method of claim 21, wherein the plurality of affordances are arranged in an order of descending significance.

25. A method for viewing and navigating between views of a data set in a graphical user interface, comprising the steps of:
displaying a personal perspective affordance bar comprising a profile affordance, a recents affordance, a favorites affordance, and a status affordance, the personal perspective affordance bar associated with a personal perspective of a data set;
displaying an organization perspective affordance bar comprising an organization hierarchy affordance and a search affordance, the organization perspective affordance bar associated with an organization perspective of the data set;
displaying a recents view of the data set, the recents view associated with the recents affordance;
receiving an input associated with the favorites affordance;
determining a transition between the recents view and a favorites view associated with the favorites affordance, the transition based at least in part on a spatial relationship between the recents affordance and the favorites affordance;
displaying the transition;
displaying the favorites view.
